(19) United States
(12) Patent Application Publication
(10) Pub. No.: US 2010/0180777 A1
(43) Pub. Date: Jul. 22, 2010

(54) Device to Prevent the Leakage of Froth from A Cooking Apparatus

(76) Inventor: Erminio Deppieri, Venice (IT)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 12/601,276

(22) PCT Filed: May 30, 2008
(86) PCT No.: PCT/IB08/01385

§ 371 Date: Nov. 23, 2009

(30) Foreign Application Priority Data
May 31, 2007 (IT) UD2007A000098

(51) Int. Cl. A47J 36/00; A47J 27/00; B65D 51/16

(52) U.S. Cl. 99/348; 99/403; 220/367.1

(57) ABSTRACT

Device (10) to prevent the leakage of froth from a cooking apparatus (11) provided with at least an internal cooking compartment (12) in which a liquid to be brought to the boil is disposed. The device (10) comprises ventilation means (16) disposed in cooperation with the cooking apparatus (11) above the cooking compartment (12), and able to direct a determinate flow of air toward the inside of the cooking apparatus (12) in order to prevent or limit the formation of froth on the liquid.

### FIELD OF THE INVENTION

The present invention concerns a device to prevent the leakage of froth from a cooking apparatus, containing a boiling liquid.

### BACKGROUND OF THE INVENTION

Cooking apparatuses are known, for domestic, industrial or community use, defining inside at least a cooking compartment open at the top, in which a plurality of foods are cooked.

It is also known that, especially when cooking liquid foods or foods that require boiling liquids to be used, there is a risk that part of the liquid may leak from the top in the form of froth, overflowing from the top of the cooking compartment. This overflow can extinguish the cooking flame, or even worse, increase it uncontrollably.

Purpose of the present invention is therefore to achieve a device that allows to prevent the leakage of froth, or other, from a cooking apparatus.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purpose, a device according to the present invention is applied to a cooking apparatus provided inside with a cooking compartment in which a liquid is disposed, possibly with other components, to be brought to the boil.

According to a characteristic feature of the present invention, the device comprises ventilation means able to be disposed in cooperation with the cooking apparatus above the cooking compartment, and able to direct a determinate flow of air toward the inside of the cooking compartment of the cooking apparatus.

The flow of air hits the surface of the boiling liquid inside the cooking compartment, substantially preventing the formation of froth and hence preventing the froth from leaking from the cooking compartment.

According to a variant, in which the cooking apparatus is able to be associated with at least a lid to temporarily close the cooking compartment, the ventilation means comprises coupling means able to allow it to be mounted on the lid.

According to another variant, in the case of the variant indicated above, the coupling means is conformed so as to keep at least a first part of the ventilation means protruding from the external surface of the lid, so as to function also as a handle for the lid.

This solution allows to reach higher cooking temperatures inside the cooking apparatus, with the same calorific power of the cooking flame.

According to another variant, the ventilation means is mounted on a relative supporting frame, whether it be coupled or able to be coupled with the cooking apparatus, or resting on the cooking surface, or attached to the wall of a kitchen, either fixed, mobile, horizontally pivoting, adjustable, pantograph or other, provided that it is able to autonomously maintain the ventilation means in a position such as to direct the flow of air inside the cooking compartment.

According to another variant, the device also comprises mixing means, operatively associated with the ventilation means, and conformed in such a way that, when the ventilation means is disposed above the cooking compartment, it is at least partly immersed in the boiling liquid, to simultaneously mix what is cooking.

The mixing can be continuous or in desired sequences, programmed or programmable.

Advantageously, the device according to the present invention is actuated electrically and comprises a battery feed unit, possibly replaceable or rechargeable, integrated on board the ventilation means.

### BRIEF DESCRIPTION OF THE DRAWINGS

These and other characteristics of the present invention will become apparent from the following description of some preferential forms of embodiment, given as a non-restrictive example with reference to the attached drawings wherein:

FIG. 1 is a longitudinal section of a first form of embodiment of the device according to the present invention applied to a cooking apparatus;

FIG. 2 is a view from above of FIG. 1;

FIG. 3 is a partly sectioned lateral view of a second form of embodiment of the device according to the present invention applied to a cooking apparatus;

FIG. 4 is a partly sectioned lateral view of a third form of embodiment of the device according to the present invention applied to a cooking apparatus;

FIG. 5 is a partly sectioned lateral view of a fourth form of embodiment of the device according to the present invention applied to a cooking apparatus.

### DETAILED DESCRIPTION OF SOME PREFERENTIAL FORMS OF EMBODIMENT

With reference to the attached drawings, a device 10 according to the present invention is applied to a cooking apparatus 11 defining an internal compartment 12 open at the top, in which a liquid is disposed, to be boiled until it is cooked, or to cook foods immersed therein, such as pasta, vegetables, meat, pulses or other.

In particular, the device 10 comprises a ventilation member 16 able to be disposed above the cooking apparatus 11, to direct a determinate flow of air inside the cooking compartment 12.

The ventilation member 16 substantially consists of a supporting structure 17, a gripping knob 21 coupled rotatably with the upper part of the supporting structure 17, and a blower grid 22 coupled with the lower part of the supporting structure 17.

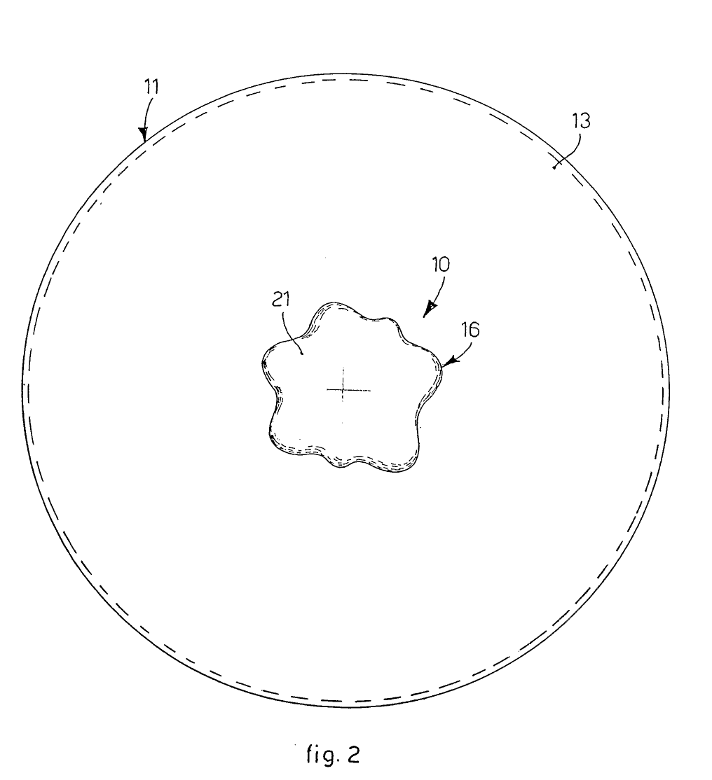

In the solution shown in FIG. 2, the gripping knob 21 has a shaped profile, but it is not excluded that it may have any other geometric or imaginative shape.

The supporting structure 17 houses inside an electric motor 19 and a ventilator with blades 20, kinematically connected with each other so that the latter is made to rotate by the electric motor 19, generating a determinate flow of air in the direction of the cooking compartment 12.

According to a variant, instead of the electric motor 19 and the ventilator with blades 20 a compressor unit may be provided, or other member suitable to generate a determinate flow of air inside the cooking compartment 12.

The gripper knob 21 houses inside it a pair of feed batteries 23, in this case replaceable, and an electric switch 25 which selectively closes the electric connection between the feed batteries 23 and the electric motor 19, causing the latter to be activated.

According to a variant, instead of the feed batteries 23 any other electric feed member is provided, also disposed externally, or distant from the ventilation member 16, such as for example photovoltaic and/or thermovoltaic panels, a feed cable connected to the mains or others, with relative electronic components.

In this case, the electric switch 25 consists of a first electric contact mounted in a determinate angular position on the gripper knob 21. By rotating the gripper knob 21 with respect to the supporting structure 17, the first contact is positioned in an angular position corresponding to the angular position of a second electric contact connected to the electric motor 19 and provided on the supporting structure 17.

According to a variant, instead of the electric switch, as described and shown, a button may be provided, or a micro-switch, a sensor or other electric or electronic device, able to allow the selective activation of the electric motor 19.

The blower grid 22 faces inside the cooking compartment 12, contains and protects the ventilator with blades 20 and comprises a plurality of through holes 26 through which the flow of air generated by the rotation of the ventilator with blades 20 is directed inside the cooking compartment 12.

According to a variant, instead of through holes 26, the blower grid 22 provides one or more blower nozzles able to be selectively directed, possibly extendible, in order to direct in a desired manner different parts or all of the flow of air generated by the ventilator with blades 20.

According to another variant, the ventilator with blades is outside the blower grid 22.

Advantageously, all the components of the ventilation member 16 can be individually dismantled, and made either of plastic or of metal material. The possibility of reciprocally dismantling the components allows to carry out a periodic and thorough cleaning and sanitization thereon, in a simple and effective manner.

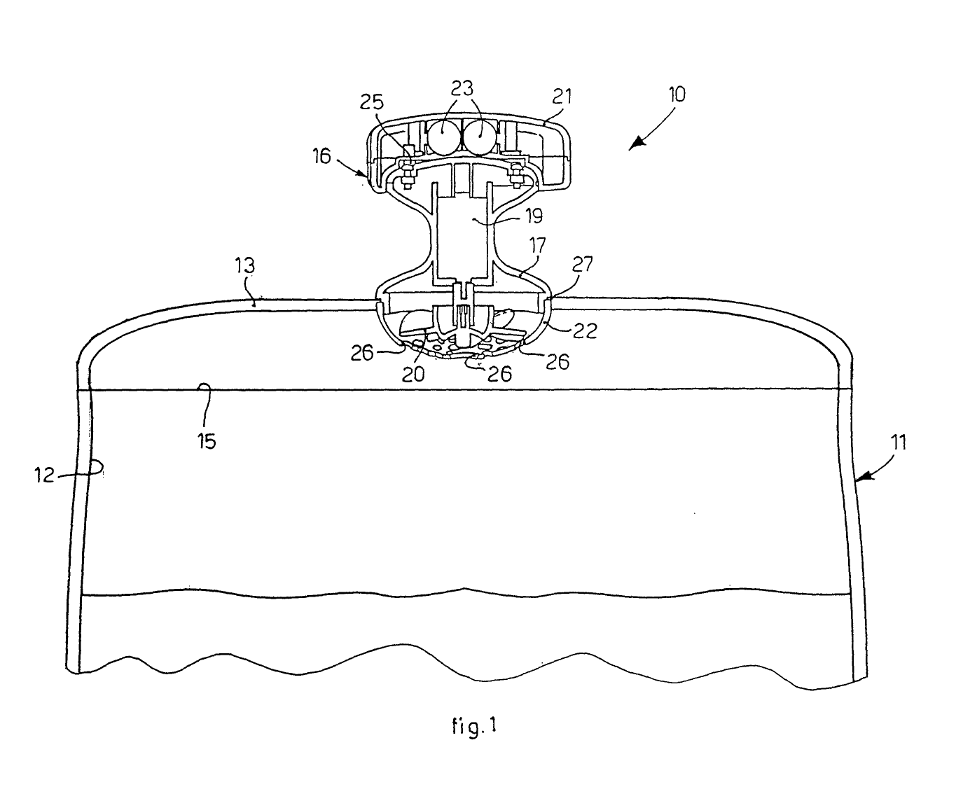

In the forms of embodiment shown in FIGS. 1, 2 and 3, the cooking compartment 12 can be selectively closed by means of a lid 13, able to be coupled with a corresponding upper edge 15 of the cooking apparatus 11.

In these forms of embodiment, the ventilation member 16 comprises a coupling groove 27 defined between the coupling edges of the supporting structure 17 and the blower grid 22.

The coupling groove 27 allows to assemble the ventilation member in a central zone of the lid 13, so as to have, when the cooking compartment 12 is in the closed condition, the blower grid 22 disposed substantially inside the cooking compartment 12, and the supporting structure 17 and the gripper knob 21 facing toward the outside of the lid 13, thus also acting as a handle for the lid 13.

According to other variants, the ventilation member 16 is directly integrated into the lid 13, or mounted in snap-in manner, by same-shape coupling, by means of ring-nuts, screws or some other known manner.

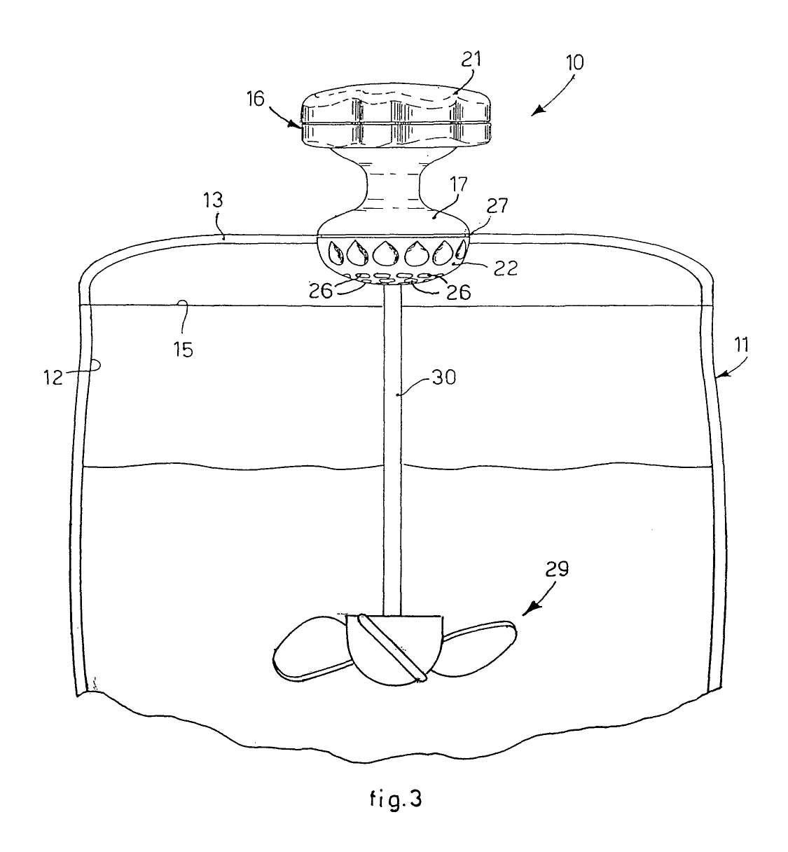

In particular, in the form of embodiment shown in FIG. 3, the device 10 according to the invention also comprises a mixer member 29. The mixing member 29 is kinematically connected to the ventilator with blades 20 by means of a transmission shaft 30, and protrudes outside the blower grid 22 so that, in the operating condition, it is at least partly immersed in the liquid. This solution improves the cooking of the foods.

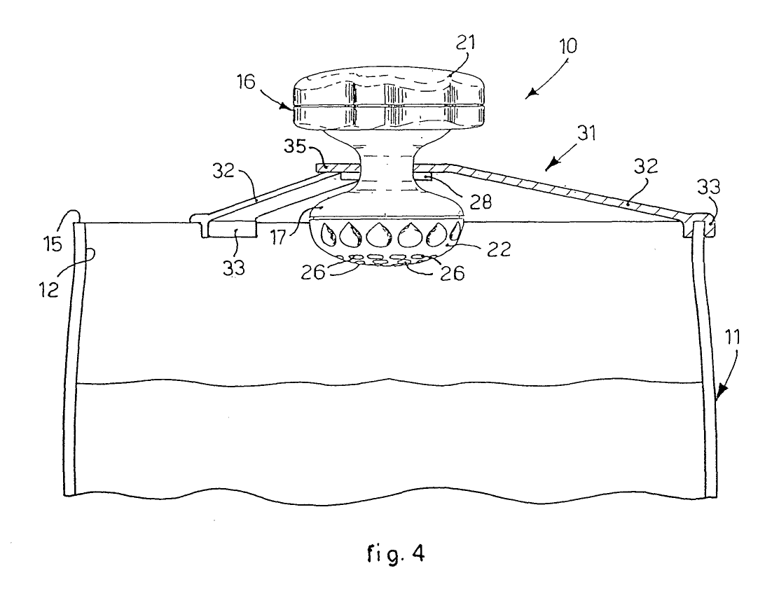

In the form of embodiment shown in FIG. 4, the ventilation member 16 is associated with the cooking apparatus 11 by means of a supporting frame 31 provided with three arms 32, of which only two are visible.

The three arms 32 are connected with each other by a connection ring 35, and each of them comprises at one end an attachment element 33 conformed so as to be constrained to the upper edge 15 of the cooking apparatus 11.

The ventilation member 16 is mounted through on the connection ring 35 and is attached to the latter, in this case, by means of an attachment ring-nut 28.

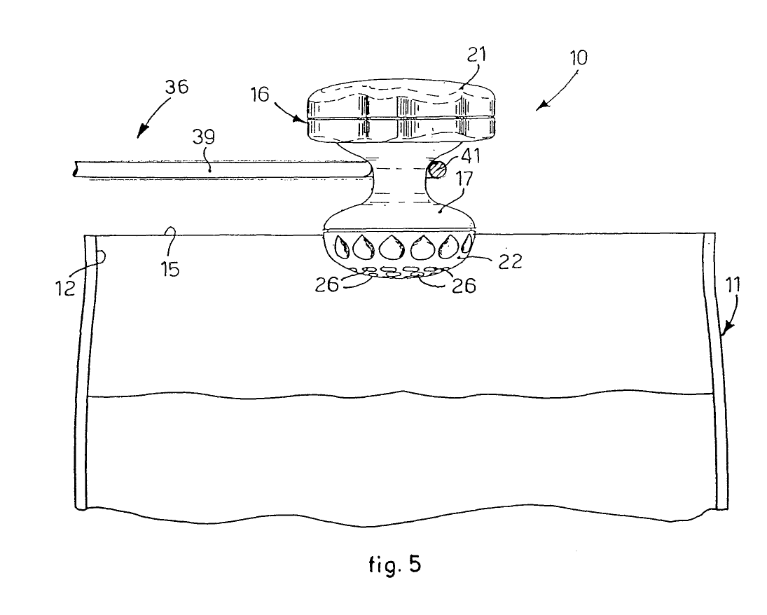

In the form of embodiment shown in FIG. 5, the ventilation member 16 is kept in cooperation with the cooking apparatus 11 by means of a supporting frame 36.

In this case, the supporting frame 36 comprises an upright, not shown, which comprises at least an eyelet 41 to retain the ventilation member 16, so as to keep it in a position such as to direct the flow of air inside the cooking compartment 12.

The upright can either be of the type associated with a supporting base of the cooking surface, or associated with a wall, or with an item of furniture.

According to some variants, not shown, the supporting cross piece 39 is of the telescopic type, of the horizontally pivoting type, or with sets of pantograph levers, or others, able to keep the ventilation member 16 in a position such as to direct the flow of air inside the cooking compartment 12.

It is clear, however, that modifications and/or additions of parts may be made to the device 10 as described heretofore, without departing from the field and scope of the present invention.

For example, it comes within the field of the present invention to provide that the device 10 also comprises accessory elements, such as sound timers and/or command units to automatically switch off, or others.

It also comes within the field of the present invention to provide that, although not specifically shown, the mixing member 29 can also be provided in the alternative forms of embodiment shown in FIGS. 4 and 5.

It is also clear that, although the present invention has been described with reference to specific examples, a person of skill in the art shall certainly be able to achieve many other equivalent forms of device to prevent the leakage of froth from a cooking apparatus, having the characteristics as set forth in the claims and hence all coming within the field of protection defined thereby.

1. Device to prevent the leakage of froth from a cooking apparatus (11) provided with at least an internal cooking compartment (12) in which a liquid to be brought to the boil is disposed, comprising ventilation means (16) able to be disposed in cooperation with the cooking apparatus (11), characterized in that said ventilation means (16) is associated with support means (13, 27, 31, 36) cooperating directly with said cooking apparatus (11), or with a part thereof, so as to position said ventilation means (16) above and in close proximity with the cooking compartment (12), so as to direct a determinate flow of air toward the inside of said cooking compartment (12) in order to prevent or limit the formation of froth on said liquid.

2. Device as in claim 1, wherein the cooking apparatus (11) comprises at least a lid (13) able to selectively close the cooking compartment (12) from above, characterized in that said support means comprises coupling means (27) able to allow the assembly of said ventilation means (16) directly on the lid (13).

3. Device as in claim 2, characterized in that said coupling means (27) is able to maintain at least a first part (17, 21) of the ventilation means (16) protruding from an external surface of the lid (13).

4. Device as in claim 2 or 3, characterized in that said coupling means (27) is able to maintain at least a second part (22) of the ventilation means (16) protruding from an internal surface of the lid (13).

5. Device as in claim 1, characterized in that said support means comprises a lid (13) able to be both selectively associated with the cooking apparatus (11) in order to close the cooking compartment (12), and also to support the ventilation means (16) in order to maintain it in a position such as to direct the flow of air inside the cooking compartment (12).

6. Device as in claim 1, characterized in that said support means comprises a supporting frame (31, 36) associated or able to be associated with the cooking apparatus (11), and able to support the ventilation means (16) in order to maintain it in a position such as to direct the flow of air inside the cooking compartment (12).

7. Device as in claim 6, characterized in that the supporting frame (31) comprises a plurality of arms (32) each having an attachment element (33) conformed so as to be constrained to an upper edge (15) of the cooking apparatus (11), and a connection ring (35) conformed to connect the arms (32) with each other, and on which the ventilation means (16) is mounted.

8. Device as in claim 6, characterized in that the supporting frame (36) comprises at least a cross piece (39) provided with an eyelet (41) to retain the ventilation means (16).

9. Device as in any claim hereinbefore, characterized in that it also comprises mixing means (26) operatively connected to the ventilation means (16) and able to be at least partly immersed in the liquid to be brought to the boil.

10. Device as in any claim hereinbefore, characterized in that said ventilation means (16) comprises at least a supporting structure (17), a gripper knob (21) coupled with the supporting structure (17), and a blower grid (22) coupled with the supporting structure (17) and facing toward the cooking compartment (12).

11. Device as in claim 10, characterized in that said ventilation means (16) comprises a drive member (19) and a ventilator member (20), kinematically connected with each other so as to generate a determinate flow of air in the direction of the cooking compartment (12).

12. Device as in claim 11, characterized in that the drive member (19) is of the electric type and is fed by at least a feed member (23).

13. Device as in claim 12, characterized in that said feed member (23) is housed inside the gripper knob (21).

14. Device as in claim 13, characterized in that said feed member comprises at least a battery (23) of the replaceable type.

15. Device as in claim 13, characterized in that said feed member (23) is rechargeable.

16. Device as in claim 12, characterized in that said feed member (23) is disposed outside the gripper knob (21).

17. Device as in claim 16, characterized in that said feed member (23) is a photovoltaic or thermovoltaic panel.

18. Device as in any claim from 10 to 15, characterized in that the gripper knob (21) houses inside it a switch (25) able to selectively connect the feed members (23) and the drive member (19).

19. Device as in claim 10, characterized in that the supporting structure (17) is able to house inside it a compressor unit able to generate a determinate flow of air in the direction of the cooking compartment (12).

20. Device as in any claim from 10 to 17, characterized in that the blower grid (22) faces inside the cooking compartment (12), contains the ventilator with blades (20) and comprises a plurality of through holes (26) through which the flow is directed inside the cooking compartment (12).

21. Device as in any claim from 10 to 17, characterized in that the blower grid (22) comprises one or more blower nozzles able to be selectively directed in order to direct the flow of air in a desired manner.
